(19) United States
(12) Patent Application Publication
(10) Pub. No.: US 2026/0094990 A1
(43) Pub. Date: Apr. 2, 2026

(54) CONNECTOR

(71) Applicant: SUMITOMO WIRING SYSTEMS, LTD., Mie (JP)

(72) Inventor: Kuniaki TANIDA, Mie (JP)

(21) Appl. No.: 19/113,425

(22) PCT Filed: Aug. 21, 2023
(86) PCT No.: PCT/JP2023/030044

§ 371 Date: Mar. 20, 2025

(30) Foreign Application Priority Data
Sep. 29, 2022 (JP) 2022-156736

(51) Int. Cl. H01R 13/436

(52) U.S. Cl. CPC H01R 13/4364

(57) ABSTRACT

A connector includes a female terminal metal fitting, a first housing, and a front retainer. The front retainer has a front wall portion arranged on a front side of the housing body and a peripheral wall portion that extends rearward from the front wall portion and surrounds an outer peripheral surface of the housing body. An outer peripheral surface of the peripheral wall portion is surrounded by a hood portion. The peripheral wall portion has an outer contact portion that contacts an inner peripheral surface of the hood portion, and an inner contact portion that contacts the outer peripheral surface of the housing body. The front retainer has a displacement allowance portion that allows displacement of the peripheral wall portion in an inward-outward direction.

### TECHNICAL FIELD

The present disclosure relates to a connector.

### BACKGROUND

Patent Document 1 discloses a configuration in which a front retainer is attached to the front end of a female housing. When a terminal metal fitting is located just before reaching the correct position (that is, in a half-inserted state) in the terminal storage portion of the female housing, a lance is elastically displaced by the terminal metal fitting. In this state, the elastically deformed lance impedes movement of the front retainer to the full-locking position. If the front retainer interferes with the elastically deformed lance, the resistance to the movement of the front retainer toward the full-locking position will increase, and the movement of the front retainer will stop before reaching the full-locking position, which makes it possible to detect the half-inserted state of the terminal metal fitting. The front holder disclosed in Patent Document 2 can also detect the half-inserted state of a terminal metal fitting.

### PRIOR ART DOCUMENT

### Patent Document

Patent Document 1: JP 2014-203633 A

Patent Document 2: JP 2008-016262 A

### SUMMARY OF THE INVENTION

### Problems to Be Solved

The front retainer of Patent Document 1 includes a projection (also serving as a locking protrusion 40L) that protrudes inward from the inner peripheral surface of the peripheral wall. For example, if this projection strongly contacts the female housing, the resistance to movement of the front retainer toward the full-locking position will increase, and the operator who operates the front retainer may recognize that the front retainer interferes with the lance, but may mistakenly determine that the terminal metal fitting is in a half-inserted state. Furthermore, the front retainer of Patent Document 1 includes a projection that protrudes outward from the outer peripheral surface of the peripheral wall portion. A deflection space is provided in a portion that is connected to the peripheral wall on the outer edge side of the front wall portion. When the projection contacts the hood portion, even if the portion with the protrusion (hereinafter, also referred to as the outer wall portion) elastically deforms into the deflection space, the projection is arranged in a circumferential direction independent of the deflection space, so that the outer wall portion may not elastically deform in a balanced manner but may elastically deform with distortion.

In view of this, an object of the present disclosure is to provide a connector that can improve the reliability of detecting the half-inserted state of a terminal metal fitting and that can maintain shape stability of a front retainer during assembly.

### Means to Solve the Problem

A connector of the present disclosure includes a terminal metal fitting, a housing that stores the terminal metal fitting and a front retainer that is attached to the housing and locks the terminal metal fitting, wherein the front retainer has a front wall portion arranged on a front side of the housing and a peripheral wall portion that extends rearward from an outer edge of the front wall portion and surrounds an outer peripheral surface of the housing, an outer peripheral surface of the peripheral wall portion is surrounded by a hood portion of a mating housing, the peripheral wall portion has an outer contact portion that contacts an inner peripheral surface of the hood portion as part of the outer peripheral surface of the peripheral wall portion, and an inner contact portion that contacts the outer peripheral surface of the housing as part of an inner peripheral surface, the front retainer has a displacement allowance portion that allows elastic displacement of the peripheral wall portion in an inward-outward direction, and with respect to a circumferential direction of the peripheral wall portion, the inner contact portion is arranged on both sides of the displacement allowance portion, and the outer contact portion is arranged between a pair of the inner contact portions.

### Effect of the Invention

According to the present disclosure, it is possible to improve the reliability of detecting the half-inserted state of a terminal metal fitting and to maintain shape stability of a front retainer during assembly.

### BRIEF DESCRIPTION OF THE DRAWINGS

FIG. 1 is an exploded perspective view of a connector according to a first embodiment.

FIG. 2 is a perspective view of a first housing as seen from the front lower side.

FIG. 3 is a front view of a second housing as seen from the front side.

FIG. 4 is a perspective view of a front retainer as seen from the front lower side.

FIG. 5 is a perspective view of the front retainer as seen from the rear upper side.

FIG. 6 is a front view of the front retainer.

FIG. 7 is a cross-sectional view taken along line A-A in FIG. 6.

FIG. 8 is a cross-sectional side view of a connector in a fitted state.

FIG. 9 is an enlarged front view of a main part of the first housing to which the front retainer is attached.

FIG. 10 is an enlarged front cross-sectional view of a main part to which a hood portion is fitted.

FIG. 11 is a perspective view of a front retainer according to another embodiment as seen from the rear lower side.

### DETAILED DESCRIPTION TO EXECUTE THE INVENTION

### Description of Embodiments of Present Disclosure

First, embodiments of the present disclosure will be listed and described.
(1) A connector of the present disclosure includes a terminal metal fitting, a housing that stores the terminal metal fitting, and a front retainer that is attached to the housing and locks the terminal metal fitting. The front retainer has a front wall portion arranged on a front side of the housing and a peripheral wall portion that extends rearward from an outer edge of the front wall portion and surrounds an outer peripheral surface of the housing. An outer peripheral surface of the peripheral wall portion is surrounded by a hood portion of a mating housing. The peripheral wall portion has an outer contact portion that contacts an inner peripheral surface of the hood portion as part of the outer peripheral surface of the peripheral wall portion, and an inner contact portion that contacts the outer peripheral surface of the housing as part of an inner peripheral surface. The front retainer has a displacement allowance portion that allows elastic displacement of the peripheral wall portion in an inward-outward direction. With respect to a circumferential direction of the peripheral wall portion, the inner contact portion is arranged on both sides of the displacement allowance portion, and the outer contact portion is arranged between a pair of the inner contact portions. With this configuration, the peripheral wall portion corresponding to the formation places of the outer contact portion and the inner contact portion can be elastically displaced in the inward-outward direction via the displacement allowance portion, so that it is possible to prevent the inner contact portion from strongly contacting the housing when the front retainer is attached to the housing. Also, the presence of the displacement allowance portion can reduce the resistance to movement, whereby it is possible to prevent the front retainer from being stopped accidentally in the course of movement.
(2) In the connector of the present disclosure, it is preferable that one displacement allowance portion is sandwiched in the circumferential direction by the pair of inner contact portions, and the outer contact portion is arranged at a position corresponding to a center in the circumferential direction of the pair of inner contact portions. With this configuration, the peripheral wall portion corresponding to the formation places of the outer contact portion and the inner contact portion can be deflected without imbalance in the circumferential direction.
(3) In the connector of the present disclosure, it is preferable that the outer contact portion is shaped to protrude outward from the outer circumferential surface of the peripheral wall portion, and the inner contact portion is shaped to protrude inward from the inner circumferential surface of the peripheral wall portion. With this configuration, it is possible to clearly identify the positions of contact with the mating side (the housing and the hood portion).
(4) In the connector of the present disclosure, the displacement allowance portion is preferably a recess that is formed in a place on the outer edge side of the front wall portion connected to the peripheral wall portion. With this configuration, it is easy for part of the peripheral wall portion to elastically deform in the inward-outward direction.
(5) In the connector of the present disclosure, it is preferable that, with respect to the circumferential direction, the pair of inner contact portions sandwich the displacement allowance portion, and the peripheral wall portion has slits formed at a pair of positions that sandwich the pair of inner contact portions. With this configuration, the shape of part of the peripheral wall portion at the location where the outer contact portion and the inner contact portion are arranged can be cantilevered, making it easier for the peripheral wall portion to elastically deform in the inward-outward direction.

### Details of Embodiments of Present Disclosure

### First Embodiment

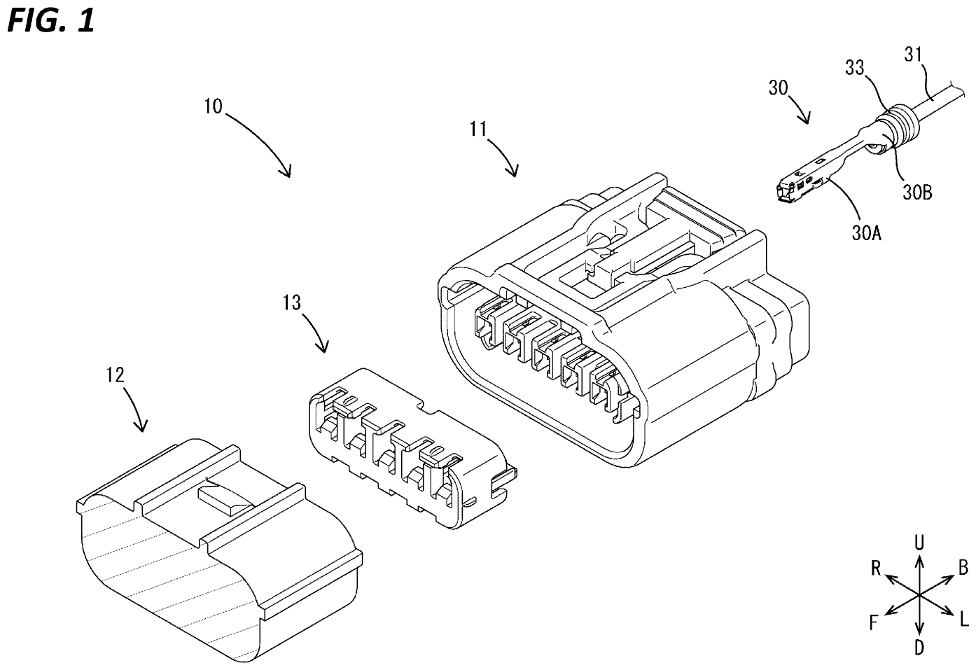

A connector 10 embodying the present disclosure will be described with reference to FIGS. 1 to 10. In the drawings, “front side”, “rear side”, “upper side”, “lower side”, “right side”, and “left side” are represented as “F”, “B”, “U”, “D”, “R”, and “L”, respectively. In the first embodiment, the horizontal direction corresponds to the width direction. As shown in FIG. 1, the connector 10 of the first embodiment includes a first housing 11 and a second housing 12 as a mating housing that can be fitted to the first housing 11, a front retainer 13, and a female terminal metal fitting 30 that is a terminal metal fitting. The front side is the side on which the second housing 12 is fitted to the first housing 11. The front side of the second housing 12 is the side on which the first housing 11 is fitted to.

### Configuration of First Housing

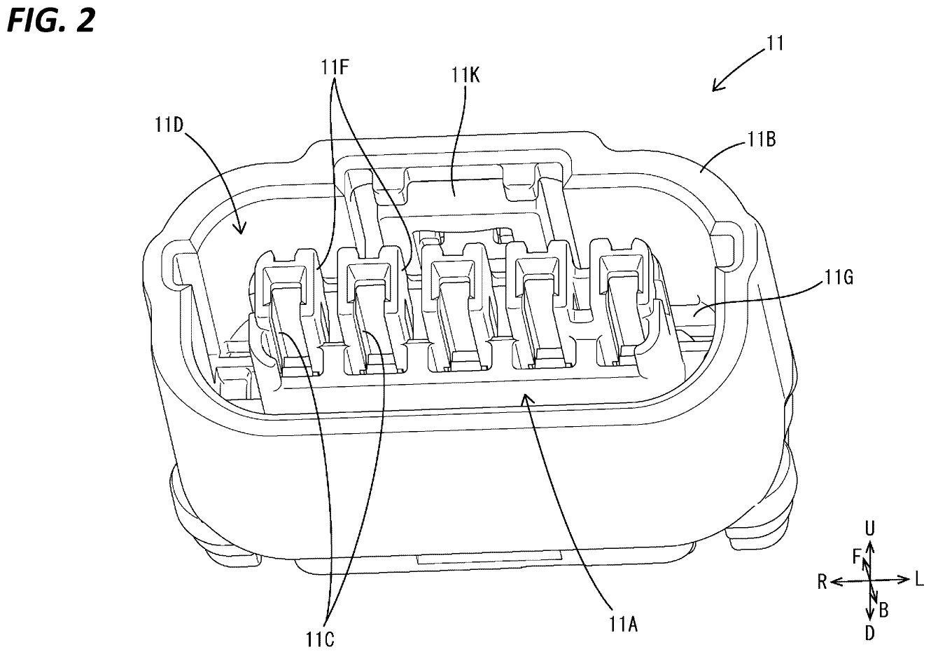

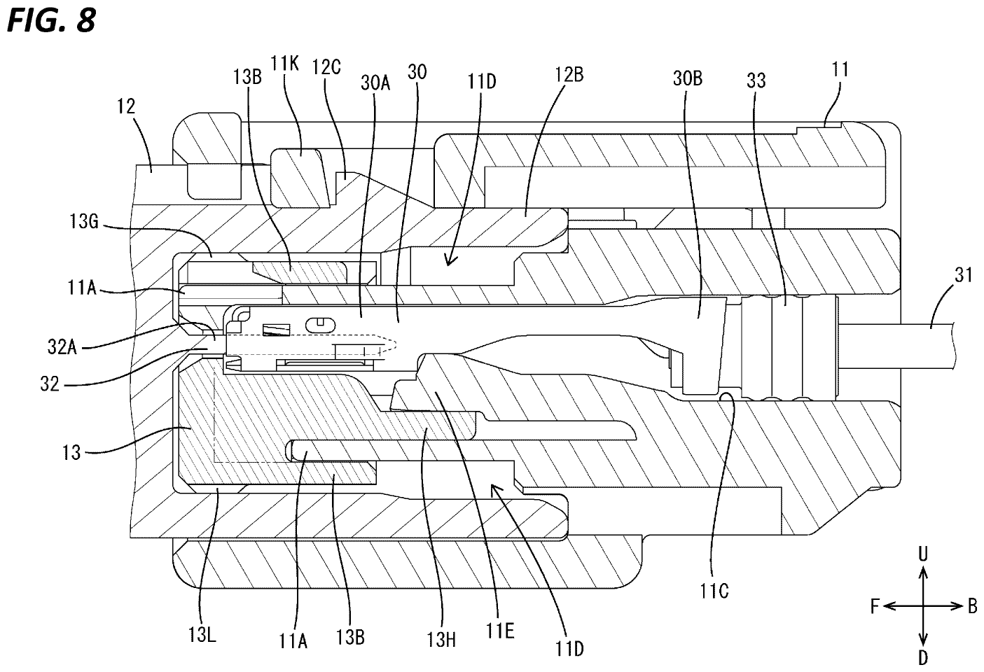

The first housing 11 is made of a synthetic resin. The first housing 11 is configured as a female housing that can store the female terminal metal fitting 30 from the rear. As shown in FIG. 2, the first housing 11 has a housing body 11A that is flat in the horizontal direction (width direction) and a cylindrical surrounding wall portion 11B that surrounds the outer periphery of the housing body 11A. A plurality of cavities 11C are formed and aligned in the horizontal direction within the housing body 11A. Alance 11E extending forward in a cantilever shape is provided on the inner surface of each cavity 11C (see FIG. 8).

Grooves 11F are formed between adjacent cavities 11C at the front end of the housing body 11A. Partition walls 13J of the front retainer 13 described later are inserted into these grooves 11F from the front.

As viewed from the front (the side on which the first housing 11 is fitted to the second housing 12), the surrounding wall portion 11B has a rectangular cylindrical shape with an upper wall, a lower wall, a left wall, and a right wall on the top, bottom, left, and right sides. Alock arm 11K is provided at the center of the upper wall of the surrounding wall portion 11B in the horizontal direction. A connecting portion 11G extending inward is provided at the rear end of the surrounding wall portion 11B. The connecting portion 11G is coupled to the outer peripheral surface of the housing body 11A. A fitting space 11D into which the second housing 12 described below can be fitted is formed between the surrounding wall portion 11B and the housing body 11A.

The female terminal metal fitting 30 is inserted into each cavity 11C from the rear. The female terminal metal fitting 30 is made of a conductive metal. As shown in FIG. 1, the female terminal metal fitting 30 is connected to a terminal end of an electric wire 31, and has a rectangular cylindrical box portion 30A at the front. A tab 32A of a male terminal metal fitting 32 described later is inserted and connected to the box portion 30A (see FIG. 8). The female terminal metal fitting 30 is retained to the cavity 11C by the lance 11E being locked to the rear end of the box portion 30A (see FIG. 8). A rubber plug 33 is fitted to the electric wire 31. The rubber plug 33 is held by a barrel portion 30B of the female terminal metal fitting 30 and is in close contact with the inner surface of the rear portion of the cavity 11C to seal the inside of the cavity 11C in a liquid-tight manner (see FIG. 8).

### Configuration of Second Housing

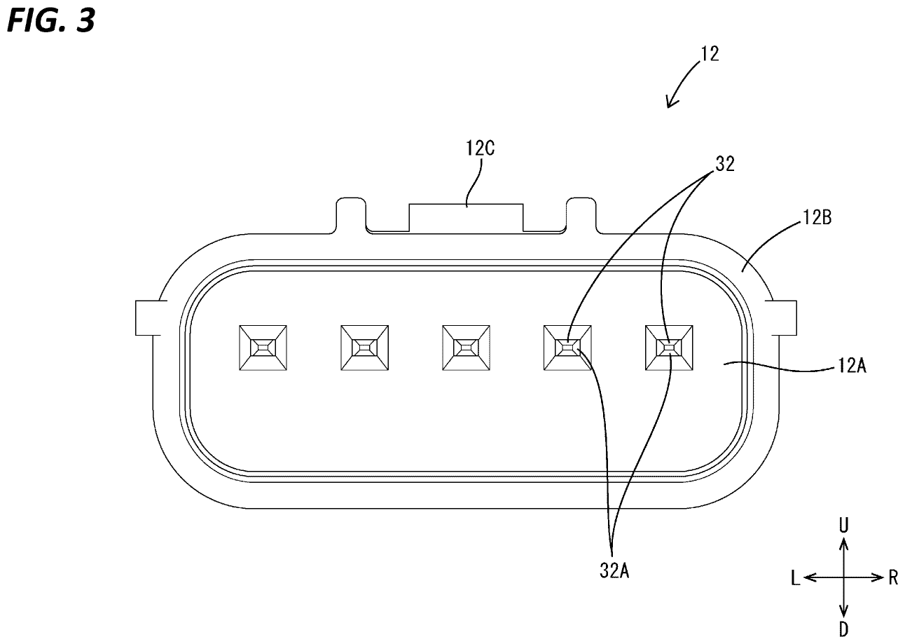

The second housing 12 is made of a synthetic resin. The second housing 12 is configured as a male housing to which the male terminal metal fittings 32 can be attached. As shown in FIG. 3, the second housing 12 has a terminal holding portion 12A that holds the male terminal metal fittings 32, and a hood portion 12B that extends forward from the outer peripheral edge of the terminal holding portion 12A in a rectangular tubular shape. In the hood portion 12B, the plurality of tabs 32A of the male terminal metal fittings 32 penetrate the terminal holding portion 12A in the front-back direction and are arranged to protrude. Alock portion 12C that protrudes upward is provided at the center of the upper wall of the hood portion 12B in the horizontal direction.

### Configuration of Front Retainer

The front retainer 13 is made of a synthetic resin. The front retainer 13 is attached to the housing body 11A from the front (see FIG. 8). When the front retainer 13 is attached to the housing body 11A, the front retainer 13 locks the female terminal metal fittings 30 and performs a function to detect the half-inserted state of each female terminal metal fitting 30.

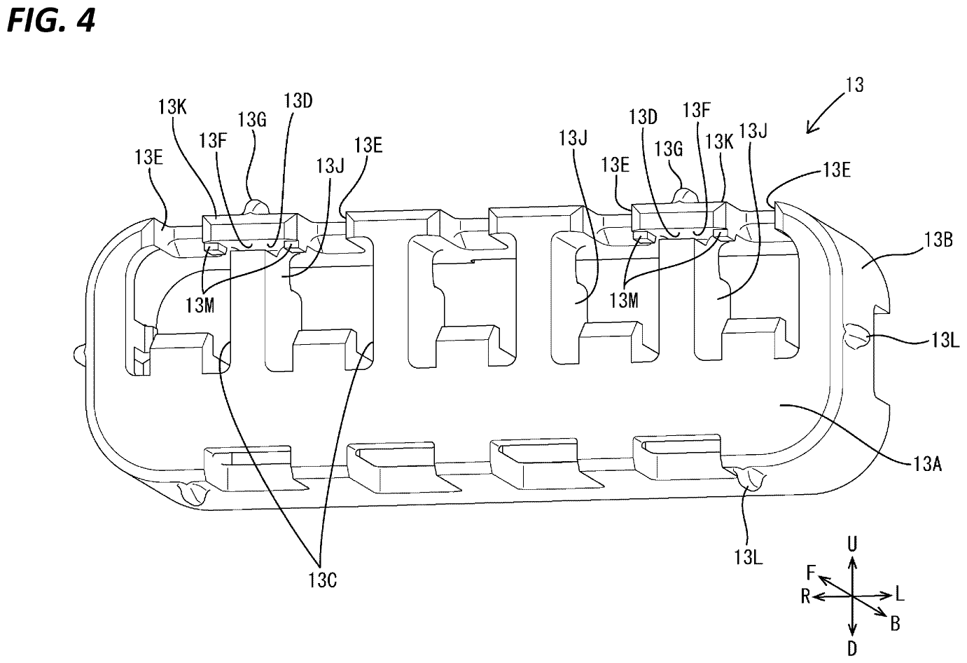

As shown in FIGS. 4 to 7, the front retainer 13 has a front wall portion 13A and a peripheral wall portion 13B that extends rearward from the outer edge of the front wall portion 13A in a rectangular cylindrical shape. When the front retainer 13 is attached to the housing body 11A, the front wall portion 13A is arranged on the front side of the housing body 11A so as to cover the lower part of the front surface (the surface facing forward) of the housing body 11A from the front (see FIG. 8). The peripheral wall portion 13B is arranged so as to surround the outer peripheral surface of the front surface of the housing body 11A (see FIG. 8).

A plurality of window holes 13C are formed through the front wall portion 13A in correspondence with the cavities 11C. When the front end of the housing body 11A is inserted into these window holes 13C, the front surface of the housing body 11A and the front surface of the front wall portion 13A are arranged flush with each other (see FIG. 8).

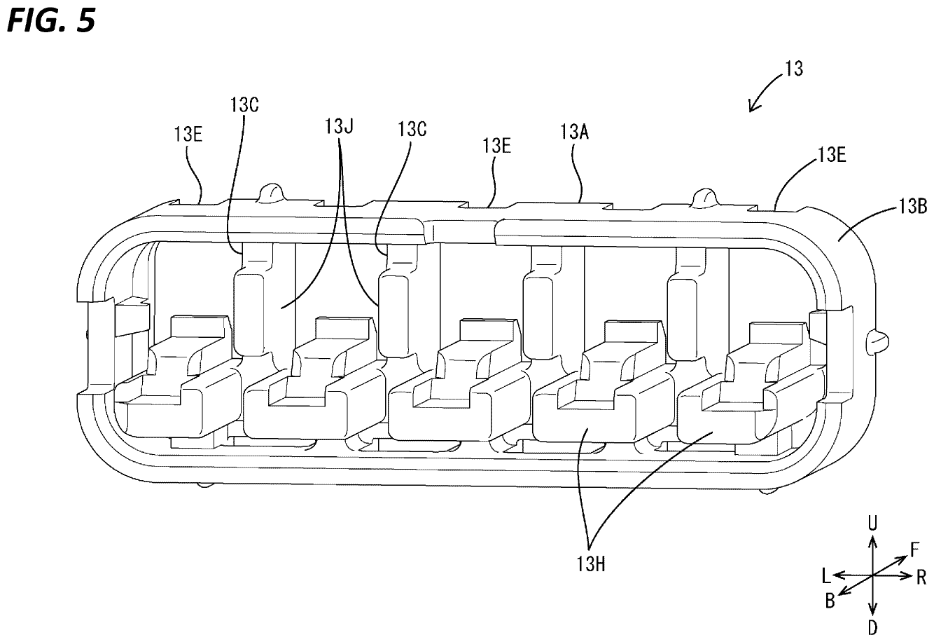

As shown in FIG. 5, the front retainer 13 includes a plurality of detection portions 13H. These detection portions 13H are aligned in the horizontal direction and extend rearward from the rear surface of the front wall portion 13A. When the front retainer 13 is properly attached to the housing body 11A, each detection portion 13H is arranged along the lower surface of the front end portion of the lance 11E (see FIG. 8). Accordingly, each detection portion 13H restricts the lance 11E from deflecting downward, and prevents the female terminal metal fitting 30 arranged in the cavity 11C from coming off from the housing body 11A. The detection portions 13H are individually provided in correspondence with the lances 11E. The front retainer 13 includes the plurality of partition walls 13J. The partition walls 13J are flat and arranged so as to partition the adjacent window holes 13C with the thickness direction as the horizontal direction.

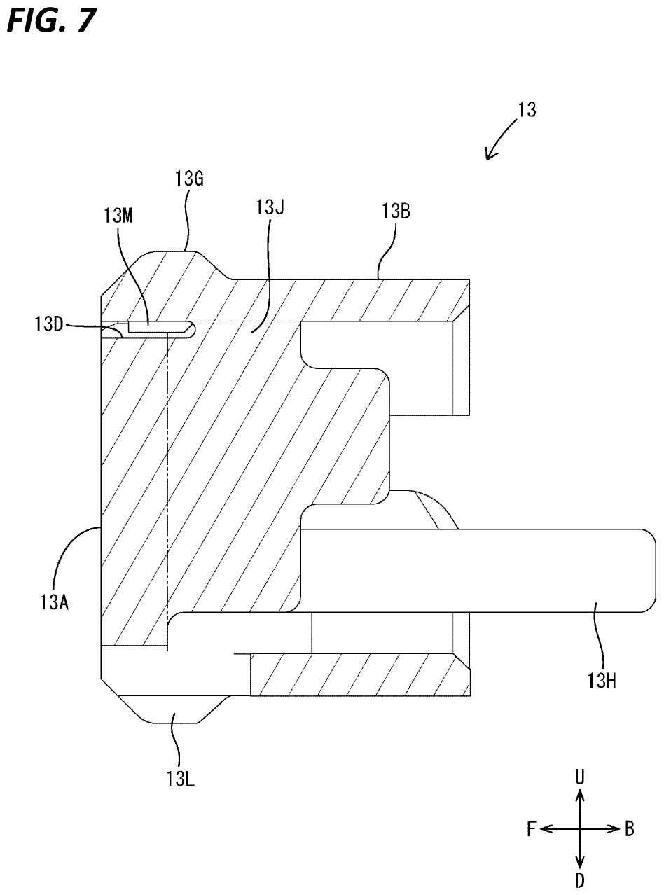

As shown in FIG. 4, two recesses 13D are provided on the front surface of the front wall portion 13A of the front retainer 13. These recesses 13D are connected to the peripheral wall portion 13B on the outer edge side of the front wall portion 13A, and are located at the upper ends of the partition walls 13J located on both sides in the horizontal direction. These recesses 13D vertically divide the front end of the peripheral wall portion 13B and the front end of the partition wall 13J, and vertically divide the front end of the peripheral wall portion 13B and the front wall portion 13A (see FIG. 7). This allows the places on the peripheral wall portion 13B corresponding to the arrangement positions of the recesses 13D (hereinafter, also referred to as displacement portions 13K) to be elastically deformed in the vertical direction (inward-outward direction). The inward-outward direction here is a direction that intersects with the front-back direction and corresponds to the direction connecting the inside and outside of the peripheral wall portion 13B, that is, corresponds to the plate-thickness direction of the peripheral wall portion 13B. In other words, the recesses 13D are displacement allowance portions 13F that allow elastic displacement of the displacement portions 13K of the peripheral wall portion 13B in the inward-outward direction.

As shown in FIGS. 4 and 5, a plurality of slits 13E recessed rearward from the front end are provided in the upper wall of the peripheral wall portion 13B of the front retainer 13. These slits 13E are arranged in correspondence with the window holes 13C. Of the plurality of slits 13E, two slits 13E adjacent to each other and located at the left end and two slits 13E adjacent to each other and located at the right end each form a pair with the recess 13D (displacement allowance portions 13F) between them in the circumferential direction (see FIG. 4).

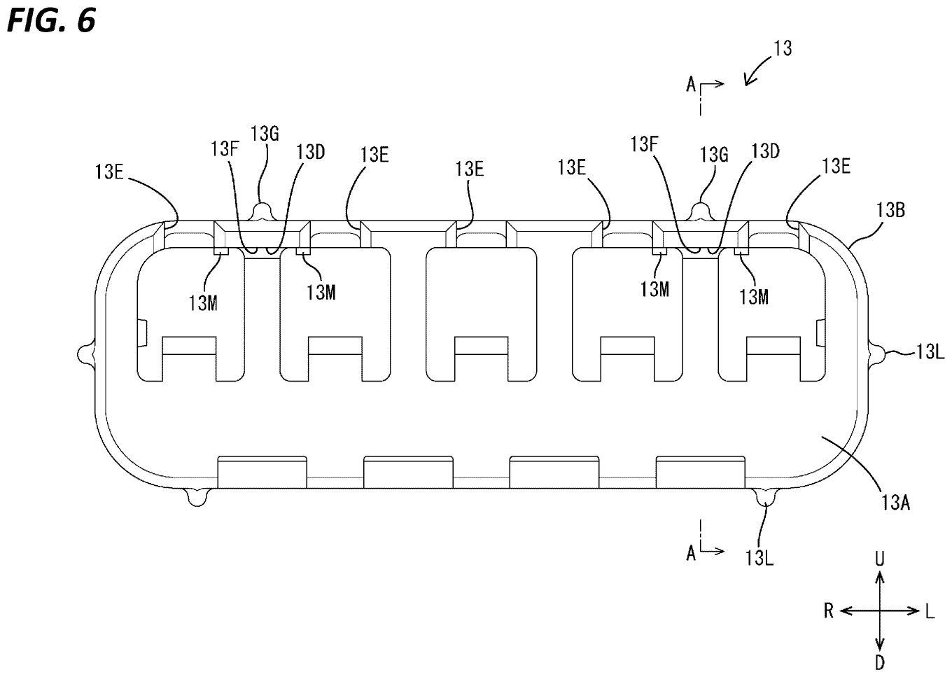

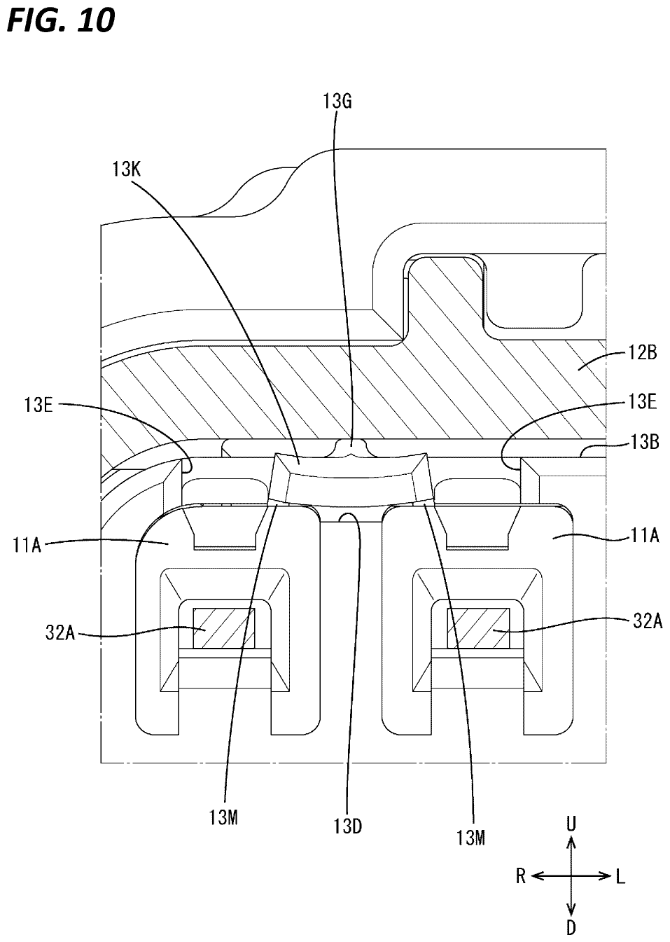

As shown in FIGS. 4 and 6, the peripheral wall portion 13B has a plurality of outer contact portions 13G, 13L and a plurality of inner contact portions 13M. The plurality of outer contact portions 13G, 13L are provided on the outer peripheral surface of the peripheral wall portion 13B so as to protrude outward. These outer contact portions 13G, 13L contact the inner peripheral surface of the hood portion 12B as part of the outer peripheral surface of the peripheral wall portion 13B (see FIG. 10). Two outer contact portions 13G are provided on the upper wall of the peripheral wall portion 13B, two outer contact portions 13L are provided on the lower wall of the peripheral wall portion 13B, and one outer contact portion 13L is provided on each of the left and right walls of the peripheral wall portion 13B. These outer contact portions 13G, 13L are formed to extend in the front-back direction (see FIG. 7). Each outer contact portion 13G provided on the upper wall of the peripheral wall portion 13B is arranged above the partition wall 13J and above the recess 13D. In other words, each outer contact portion 13G is arranged within a formation range of one recess 13D (displacement allowance portion 13F) with respect to the circumferential direction of the upper wall of the peripheral wall portion 13B.

The four inner contact portions 13M are arranged on the inner peripheral surface of the upper wall of the peripheral wall portion 13B and protrude downward (inward) from the inner peripheral surface of the peripheral wall portion 13B. These inner contact portions 13M are formed to extend in the front-back direction (see FIG. 7). The lower ends of the inner contact portions 13M are formed in a plane parallel to the inner peripheral surface of the peripheral wall portion 13B. Among the inner contact portions 13M, the two inner contact portions 13M on the left side are arranged so as to sandwich the partition wall 13J and the recess 13D at the left end from the horizontal direction. Among the inner contact portions 13M, the two inner contact portions 13M on the right side are arranged so as to sandwich the partition wall 13J and the recess 13D at the right end from the horizontal direction. In other words, the inner contact portions 13M are arranged on both sides of the corresponding recess 13D (displacement allowance portion 13F) with respect to the circumferential direction of the peripheral wall portion 13B.

As shown in FIG. 6, each outer contact portion 13G provided on the upper wall of the peripheral wall portion 13B is arranged at a position corresponding to the center in the circumferential direction of the peripheral wall portion 13B of the pair of inner contact portions 13M that sandwich the recess 13D (displacement allowance portions 13F) in the circumferential direction of the peripheral wall portion 13B. In other words, each outer contact portion 13G provided on the upper wall of the peripheral wall portion 13B is arranged between the pair of inner contact portions 13M that sandwich the recess 13D (displacement allowance portion 13F) in the circumferential direction of the peripheral wall portion 13B. With respect to the circumferential direction of the peripheral wall portion 13B, the slits 13E except for the slit 13E at the center in the horizontal direction are paired so as to sandwich the pair of inner contact portions 13M that sandwich the recess 13D (displacement allowance portions 13F) in the circumferential direction of the peripheral wall portion 13B.

### Assembly Form of Each Member in Connector

As shown in FIG. 8, when the female terminal metal fitting 30 is inserted into the cavity 11C from the rear and placed in the proper position in the cavity 11C, the front end of the lance 11E faces the rear end of the box portion 30A of the female terminal metal fitting 30 from the rear.

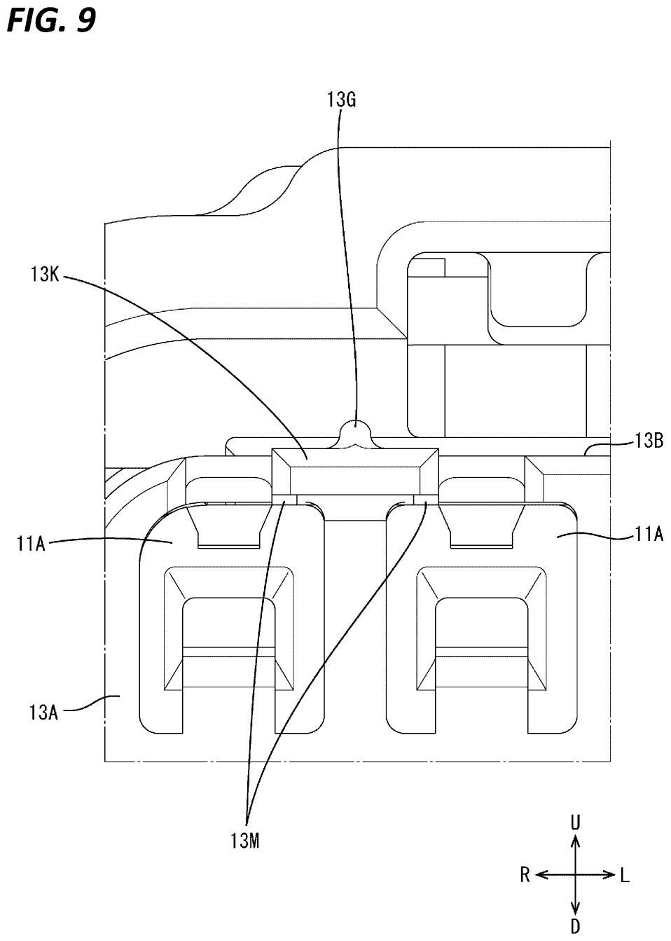

Then, the front retainer 13 is attached to the housing body 11A from the front. At this time, the posture of the front retainer 13 is adjusted such that the detection portion 13H faces the lance 11E and the rear end of the detection portion 13H is lower than the front end of the lance 11E. When the front retainer 13 is attached to the housing body 11A, each inner contact portion 13M contacts the upper end surface (outer peripheral surface) of the housing body 11A as part of the inner peripheral surface of the peripheral wall portion 13B and is pressed upward by the housing body 11A as shown in FIG. 9. Accordingly, the peripheral wall portion 13B (displacement portion 13K) at the place where the inner contact portion 13M is arranged elastically deforms in the inward-outward direction (upward in the vertical direction). This prevents the inner contact portion 13M from contacting excessively strongly the upper end surface (outer peripheral surface) of the housing body 11A.

As shown in FIG. 8, when the front retainer 13 is attached to the housing body 11A, each detection portion 13H of the front retainer 13 is arranged along the lower surface of the front end portion of the lance 11E. Accordingly, the detection portion 13H restricts downward deflection of the lance 11E and holds the female terminal metal fitting 30 in the cavity 11C in a retained state. In addition, when the front retainer 13 is attached to the housing body 11A, the partition wall 13J (not shown) is inserted from the front into each groove 11F of the housing body 11A.

The second housing 12 is attached from the front to the first housing 11 to which the female terminal metal fittings 30 and the front retainer 13 are attached. At this time, the posture of the second housing 12 is adjusted such that the hood portion 12B faces the housing body 11A and the lock portion 12C faces the lock arm 11K. When the second housing 12 is attached to the first housing 11 in this posture, the outer contact portions 13G, 13L contact the inner peripheral surface of the hood portion 12B as part of the peripheral wall portion 13B.

At this time, each outer contact portion 13G provided on the upper wall of the peripheral wall portion 13B is pressed downward by the upper wall of the hood portion 12B and is slightly crushed as shown in FIG. 10. The inner contact portions 13M are also slightly crushed. The peripheral wall portion 13B at the place where the outer contact portion 13G is arranged on the upper wall of the peripheral wall portion 13B elastically deforms inward in the inward-outward direction (downward in the vertical direction). Therefore, the peripheral wall portion 13B (displacement portion 13K) between the two slits 13E sandwiching the recess 13D deflects upward on both sides in the circumferential direction and deflects downward at the center in the circumferential direction. Accordingly, the front retainer 13 prevents the inner contact portion 13M from contacting excessively strongly the outer peripheral surface of the housing body 11A, while preventing the outer contact portion 13G from contacting excessively strongly the inner peripheral surface of the hood portion 12B.

When the second housing 12 is fitted to the first housing 11 to which the female terminal metal fittings 30 and the front retainer 13 are attached, each hood portion 12B is inserted into the fitting space 11D of the first housing 11 from the front of the first housing 11, as shown in FIG. 8. Then, the lock portion 12C is locked to the lock arm 11K of the first housing 11. Along with this, the tab 32A of the male terminal metal fitting 32 is inserted into the box portion 30A from the front of the female terminal metal fitting 30. The hood portion 12B of the second housing 12 is fitted so as to surround the outer circumferential surface of the peripheral wall portion 13B of the front retainer 13. The housing body 11A and the front retainer 13 are stored in the hood portion 12B of the second housing 12.

Next, the operation of the first embodiment will be described.

The connector 10 of the present disclosure includes the female terminal metal fitting 30, the first housing 11 that stores the female terminal metal fitting 30, and the front retainer 13 that is attached to the housing body 11A of the first housing 11 and locks the female terminal metal fitting 30. The front retainer 13 has the front wall portion 13A that is arranged on the front side of the housing body 11A of the first housing 11, and the peripheral wall portion 13B that extends rearward from the outer edge of the front wall portion 13A and surrounds the outer peripheral surface of the housing body 11A. The outer peripheral surface of the peripheral wall portion 13B is surrounded by the hood portion 12B of the second housing 12. The peripheral wall portion 13B has the outer contact portions 13G that contact the inner peripheral surface of the hood portion 12B as part of the outer peripheral surface of the peripheral wall portion 13B, and the inner contact portions 13M that contact the outer peripheral surface of the housing body 11A as part of the inner peripheral surface. The front retainer 13 has the displacement allowance portions 13F that allow elastic displacement of the peripheral wall portion 13B in the inward-outward direction. With respect to the circumferential direction of the peripheral wall portion 13B, the inner contact portions 13M are arranged on both sides of one displacement allowance portion 13F, and the outer contact portions 13G are arranged outside between the pair of inner contact portions 13M (within the formation range in the circumferential direction of one displacement allowance portion 13F).

With this configuration, the peripheral wall portion 13B corresponding to the formation places of the outer contact portions 13G and the inner contact portions 13M can be elastically displaced in the vertical direction (inward-outward direction) via the displacement allowance portions 13F, so that it is possible to prevent the inner contact portions 13M from contacting excessively strongly the housing body 11A when the front retainer 13 is attached to the first housing 11. Also, the presence of the displacement allowance portions 13F can reduce the resistance to movement, whereby it is possible to prevent the front retainer 13 from being stopped accidentally in the course of movement.

In the connector 10 of the present disclosure, one displacement allowing portion 13F is sandwiched in the circumferential direction by the pair of inner contact portions 13M located at both ends of the recess 13D, and each outer contact portion 13G is arranged at a position corresponding to the center of the pair of inner contact portions 13M in the circumferential direction. With this configuration, the peripheral wall portion 13B (displacement portions 13K) corresponding to the formation places of the outer contact portions 13G and the inner contact portions 13M on the peripheral wall portion 13B can be deflected without imbalance in the circumferential direction.

In the connector 10 of the present disclosure, the outer contact portions 13G are shaped to protrude outward from the outer circumferential surface of the peripheral wall portion 13B, and the inner contact portions 13M are shaped to protrude inward from the inner circumferential surface of the peripheral wall portion 13B. With this configuration, it is possible to clearly identify the positions of contact with the mating side (the housing body 11A and the hood portion 12B).

In the connector 10 of the present disclosure, the displacement allowance portions 13F are recesses 13D that are formed so as to be recessed rearward in portions on the outer edge side of the front wall portion 13A connected to the peripheral wall portion 13B. With this configuration, it is easy for the front end portion (part) of the peripheral wall portion 13B to elastically deform in the vertical direction (inward-outward direction). Accordingly, as well as the front end portion of the peripheral wall portion 13B, the outer contact portions 13G and the inner contact portions 13M can easily elastically deform in the vertical direction (inward-outward direction).

In the connector 10 of the present disclosure, with respect to the circumferential direction, the pair of inner contact portions 13M sandwich the displacement allowance portion 13F, and the peripheral wall portion 13B has slits 13E formed at a pair of positions that sandwich the pair of inner contact portions 13M. With this configuration, the shape of part of the peripheral wall portion 13B (displacement portions 13K) at the arrangement places of the outer contact portions 13G and the inner contact portions 13M can be a cantilever shape extending forward, so that the front end (displacement portions 13K) of the peripheral wall portion 13B can easily elastically deform in the vertical direction (inward-outward direction).

### Other Embodiments of Present Disclosure

The present disclosure is not limited to the first embodiment described above and illustrated in the drawings. It should be noted that the present invention is intended to include all modifications within a meaning and scope equivalent to the scope of claims, and is intended to include embodiments as described below.

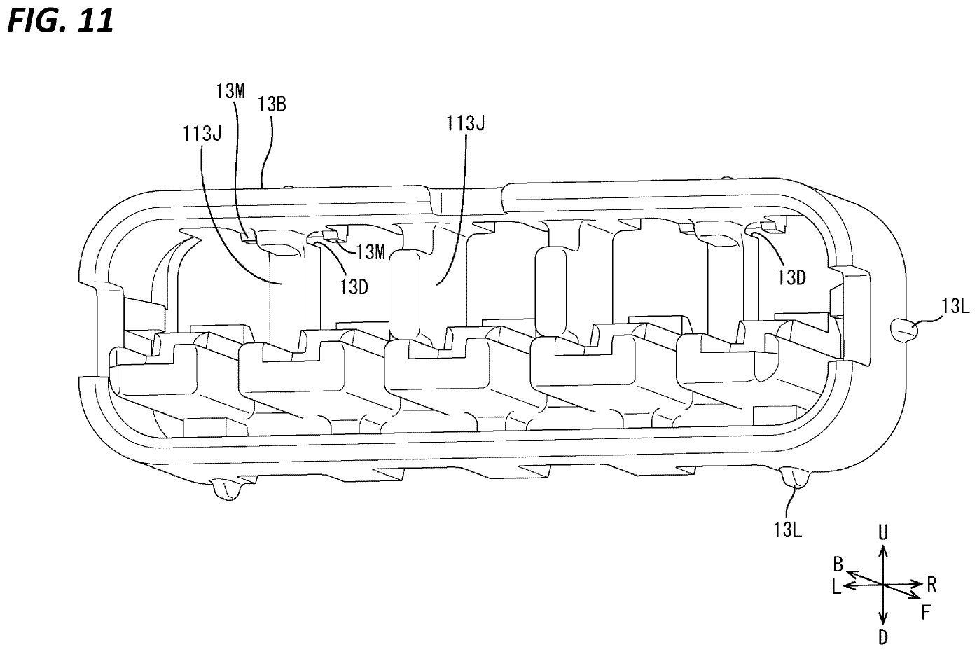

As shown in FIG. 11, among partition walls 113J, the partition walls 113J with recesses 13D may be cut out at the rear side. With this configuration, a peripheral wall portion 13B is likely to deflect at the arrangement places of the recesses 13D.

Unlike in the first embodiment, outer contact portions and inner contact portions of a front retainer may be formed flush with an outer peripheral surface and an inner peripheral surface of a peripheral wall portion, protrusions protruding inward from the inner peripheral surface of a hood portion may contact the outer contact portions, and protrusions protruding outward from the outer peripheral surface of a housing body may contact the inner contact portions.

Unlike in the first embodiment, slits may be provided in the left wall, right wall and bottom wall of a peripheral wall portion, and recesses may be provided at places connected to the left wall, right wall and bottom wall of a front wall portion.

Unlike in the first embodiment, male terminal metal fittings may be attached to a first housing.

Unlike in the first embodiment, a plurality of outer contact portions may be provided between a pair of inner contact portions.

Unlike in the first embodiment, outer contact portions may be formed at positions away from the center in the circumferential direction within a formation range between a pair of inner contact portions.

Unlike in the first embodiment, a plurality of sets of inner contact portions may be provided for one recess.

Unlike in the first embodiment, recesses may be recessed forward in the rear surface of a front wall portion.

### List of Reference Numerals

10 Connector
11 First housing
11A Housing body (housing)
11E Surrounding wall portion
111C Cavity
11D Fitting space
11E Lance
11F Groove
11G Connecting portion
11K Lock arm
12 Second housing (mating housing)
12A Terminal holding portion
12B Hood portion
12C Lock portion
13 Front retainer
13A Front wall portion
13B Peripheral wall portion
13C Window hole
13D Recess (13F Displacement allowance portion)
13E Slit
13G, 13L Outer contact portion
13H Detection portion
13J, 113J Partition wall
13K Displacement portion
13M Inner contact portion
30 Female terminal metal fitting (terminal metal fitting)
30A Box portion
30B Barrel portion
31 Electric wire
32 Male terminal metal fitting
32A Tab
33 Rubber plug

1. A connector comprising:
a terminal metal fitting;
a housing that stores the terminal metal fitting; and
a front retainer that is attached to the housing and locks the terminal metal fitting, wherein
the front retainer has a front wall portion arranged on a front side of the housing and a peripheral wall portion that extends rearward from an outer edge of the front wall portion and surrounds an outer peripheral surface of the housing,
an outer peripheral surface of the peripheral wall portion is surrounded by a hood portion of a mating housing,
the peripheral wall portion has an outer contact portion that contacts an inner peripheral surface of the hood portion as part of the outer peripheral surface of the peripheral wall portion, and an inner contact portion that contacts the outer peripheral surface of the housing as part of an inner peripheral surface,
the front retainer has a displacement allowance portion that allows elastic displacement of the peripheral wall portion in an inward-outward direction, and
with respect to a circumferential direction of the peripheral wall portion, the inner contact portion is arranged on both sides of the displacement allowance portion, and the outer contact portion is arranged between a pair of the inner contact portions.

2. The connector according to claim 1, wherein
one displacement allowance portion is sandwiched in the circumferential direction by the pair of inner contact portions, and
the outer contact portion is arranged at a position corresponding to a center in the circumferential direction of the pair of inner contact portions.

3. The connector according to claim 1, wherein
the outer contact portion is shaped to protrude outward from the outer circumferential surface of the peripheral wall portion, and
the inner contact portion is shaped to protrude inward from the inner circumferential surface of the peripheral wall portion.

4. The connector according to claim 1, wherein the displacement allowance portion is a recess that is formed in a place on an outer edge side of the front wall portion connected to the peripheral wall portion.

5. The connector according to claim 4, wherein
with respect to the circumferential direction, the pair of inner contact portions sandwich the displacement allowance portion, and
the peripheral wall portion has slits formed at a pair of positions that sandwich the pair of inner contact portions.
